(19) United States
(12) Patent Application Publication
(10) Pub. No.: US 2024/0353249 A1
(43) Pub. Date: Oct. 24, 2024

(54) DOWNHOLE FLOW METER FOR ELECTRICAL SUBMERSIBLE PUMP (ESP) APPLICATIONS

(71) Applicant: SAUDI ARABIAN OIL COMPANY, Dhahran (SA)

(72) Inventors: Sakethraman Mahalingam, Aberdeen (GB); Christopher Wrighton, Aberdeenshire (GB); Vjay Ramakrishnan, Houston, TX (US); Muhammad Arsalan, Dhahan (SA)

(73) Assignees: Aramco Overseas Company UK Ltd, London (GB); ARAMCO SERVICES COMPANY, Houston, TX (US); SAUDI ARABIAN OIL COMPANY, Dharan (SA)

(21) Appl. No.: 18/306,057

(22) Filed: Apr. 24, 2023

(51) Int. Cl. G01F 1/74; E21B 47/06

(52) U.S. Cl. CPC G01F 1/74; E21B 47/06

(57) ABSTRACT

A system for determining a flow rate of a fluid in a well includes an electrical submersible pump disposed in the well, a motor disposed on the electrical submersible pump, and a downhole sensor module connected to the motor. The electrical submersible pump includes a vertical axis. The system includes a metering module extending from the downhole sensor module including a plurality of dynamic pressure sensors along the vertical axis. The plurality of dynamic pressure sensors are connected to an outer diameter of the metering module. The plurality of dynamic pressure sensors are configured to measure a pressure fluctuation of the fluid. The system includes a processor configured to receive data from the plurality of dynamic pressure sensors and determine the flow rate of the fluid based on the received data.

### BACKGROUND

In hydrocarbon well development, it is common practice to use electrical submersible pumping systems (ESPs) as a primary form of artificial lift. It is common in the industry of ESP operations for the well to operate in a high-vibration environment. In high-vibration environments, flowmeters may inaccurately measure flow rate of fluids below the ESP due to noise production from the ESP. The flow rate of fluids below the ESP is important for evaluating in-flow performance of the well.

Accordingly, there exists a need for a mechanical damping and algorithmic compensation of vibration flowmeter to measure downhole flow rate of fluids below an ESP produced from the well.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In one aspect, embodiments disclosed herein relate to a system for determining a flow rate of a fluid in a well, the system comprising: an electrical submersible pump disposed in the well, wherein the electrical submersible pump comprises a vertical axis; a motor disposed on the electrical submersible pump; a downhole sensor module connected to the motor; a metering module extending from the downhole sensor module comprising a plurality of dynamic pressure sensors along the vertical axis, wherein the plurality of dynamic pressure sensors are connected to an outer diameter of the metering module, wherein the plurality of dynamic pressure sensors are configured to measure a pressure fluctuation of the fluid; and a processor configured to receive data from the plurality of dynamic pressure sensors and determine the flow rate of the fluid based on the received data.

In one aspect, embodiments disclosed herein relate to a method for measuring a flow rate of a fluid in a well, the method comprising: attaching a downhole sensor module to a motor disposed in the well, wherein the motor is attached to an electrical submersible pump having a vertical axis; attaching a metering module extending from the downhole sensor module, wherein the metering module comprises a plurality of dynamic pressure sensors along the vertical axis, measuring a pressure fluctuation of the fluid, via the plurality of dynamic pressure sensors connected to an outer diameter of the metering module; receiving, by a processor, the measurement of the pressure fluctuation of the fluid; and determining, using the processor, the flow rate based on the measurement of the pressure fluctuation of the fluid.

Other aspects and advantages of the claimed subject matter will be apparent from the following description and the appended claims.

### BRIEF DESCRIPTION OF DRAWINGS

FIG. 1 shows an exemplary well with an Electrical Submersible Pump (ESP) completion design in accordance with one or more embodiments.

FIG. 2 shows a cross sectional view of a pipe's flow velocity profile.

FIG. 3 shows a system in accordance with one or more embodiments.

FIGS. 4-7 show examples of the system in FIG. 3 in accordance with one or more embodiments.

FIG. 8 shows a cross-correlation of dynamic pressure measurements in accordance with one or more embodiments.

FIG. 9 shows a graph in accordance with one or more embodiments.

FIG. 10 shows a computer system in accordance with one or more embodiments.

FIG. 11 shows a flow chart in accordance with one or more embodiments.

### DETAILED DESCRIPTION

Specific embodiments of the disclosed technology will now be described in detail with reference to the accompanying figures. Like elements in the various figures are denoted by like reference numerals for consistency. The sizes and relative positions of elements in the drawings are not necessarily drawn to scale. For example, the shapes of various elements and angles are not necessarily drawn to scale, and some of these elements may be arbitrarily enlarged and positioned to improve drawing legibility. Further, the particular shapes of the elements as drawn are not necessarily intended to convey any information regarding the actual shape of the particular elements and have been solely selected for ease of recognition in the drawing.

Throughout the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as using the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

In one aspect, embodiments disclosed herein relate to a system for determining a flow rate of a fluid in a well. Specifically, a flowmeter for measuring the flow rate of fluids below an Electrical Submersible Pump (ESP). The flow rate of fluids below an ESP may provide information on the in-flow performance (IPR) of a reservoir.

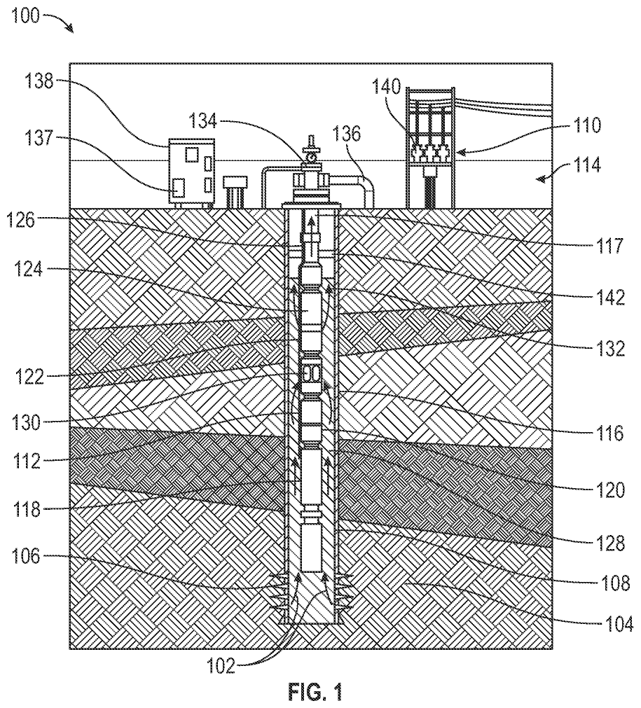

FIG. 1 shows an exemplary Electrical Submersible Pump (ESP) system (100). The ESP system (100) is one example of an artificial lift system that is used to help produce fluids (102) from a formation (104). The well (116) may be open hole or include perforations (106). Perforations (106) in the well's (116) casing string (108) provide a conduit for the fluids (102) to enter the well (116) from the formation (104). An ESP system (100) is an example of the artificial lift system, ESP system and artificial lift system may be used interchangeably within this disclosure. The ESP system (100) includes surface equipment (110) and an ESP string (112). The ESP string (112) is deployed in a well (116) on production tubing (117) and the surface equipment (110) is located on the surface (114). The production tubing (117) extends to the surface (114) and is made of a plurality of tubulars connected together to provide a conduit for fluids (102) to migrate to the surface (114). The surface (114) is any location outside of the well (116), such as the Earth's surface.

The ESP string (112) may include a motor (118), motor protectors (120), a gas separator (122), a multi-stage centrifugal pump (124) (herein called a “pump” or “ESP” (124)), and a power cable (126). The ESP string (112) may also include various pipe segments of different lengths to connect the components of the ESP string (112). The motor (118) is a downhole submersible motor (118) that provides power to the pump (124). The motor (118) may be a two-pole, three-phase, squirrel-cage induction electric motor (118). The motor's (118) operating voltages, currents, and horsepower ratings may change depending on the requirements of the operation.

The size of the motor (118) is dictated by the amount of power that the pump (124) requires to lift an estimated volume of fluids (102) from the bottom of the well (116) to the surface (114). The motor (118) is cooled by the fluids (102) passing over the motor housing. The motor (118) is powered by the power cable (126). The power cable (126) may also provide power to downhole pressure sensors or onboard electronics that may be used for communication. The power cable (126) is an electrically conductive cable that is capable of transferring information. The power cable (126) transfers energy from the surface equipment (110) to the motor (118). The power cable (126) may be a three-phase electric cable that is specially designed for downhole environments. The power cable (126) may be clamped to the ESP string (112) in order to limit power cable (126) movement in the well (116). The power cable (126) may be a single round power cable. The power cable (126) may be in the annulus between the production tubing (117) and casing string (108), from now on referred to as “the annulus (128)”. The annulus (128) is the space in the well (116) between the casing string (108) and the ESP string (112). In further embodiments, the ESP string (112) may have a hydraulic line that is a conduit for hydraulic fluid. The hydraulic line may act as a sensor to measure downhole parameters such as discharge pressure from the outlet of the pump (124).

Motor protectors (120) are located above (i.e., closer to the surface (114)) the motor (118) in the ESP string (112). The motor protectors (120) are a seal section that houses a thrust bearing. The thrust bearing accommodates axial thrust from the pump (124) such that the motor (118) is protected from axial thrust. The seals isolate the motor (118) from fluids (102). The seals further equalize the pressure in the annulus (128) with the pressure in the motor (118). The pump intake (130) is the section of the ESP string (112) where the fluids (102) enter the ESP string (112) from the annulus (128).

The pump intake (130) is located above the motor protectors (120) and downhole from the pump (124). The depth of the pump intake (130) is designed based off of the formation (104) pressure, estimated height of fluids (102) in the annulus (128), and optimization of pump (124) performance. If the fluids (102) have associated gas, then a gas separator (122) may be installed in the ESP string (112) above the pump intake (130) but below the pump (124). The gas separator (122) removes the gas from the fluids (102) and injects the gas (depicted as separated gas (132) in FIG. 1) into the annulus (128). If the volume of gas exceeds a designated limit, a gas handling device may be installed below the gas separator (122) and above the pump intake (130).

The pump (124) is located above the gas separator (122) and lifts the fluids (102) to the surface (114). The pump (124) has a plurality of stages that are stacked upon one another. Each stage contains a rotating impeller and stationary diffuser. As the fluids (102) enter each stage, the fluids (102) pass through the rotating impeller to be centrifuged radially outward gaining energy in the form of velocity. The fluids (102) enter the diffuser, and the velocity is converted into pressure. As the fluids (102) pass through each stage, the pressure continually increases until the fluids (102) obtain the designated discharge pressure and has sufficient energy to flow to the surface (114).

A packer (142) is disposed around the ESP string (112). Specifically, the packer (142) may be located above (i.e., closer to the surface (114)) the multi-stage centrifugal pump (124) or below the multi-stage centrifugal pump (124). The packer (142) may be any packer (142) known in the art such as a mechanical packer (142). The packer (142) seals the annulus (128) space located between the ESP string (112) and the casing string (108). This prevents the fluids (102) from migrating past the packer (142) in the annulus (128).

In other embodiments, sensors may be installed in various locations along the ESP string (112) to gather downhole data such as pump intake volumes, discharge pressures, shaft speeds and positions, and temperatures. The number of stages is determined prior to installation based of the estimated required discharge pressure. Over time, the formation (104) pressure may decrease and the height of the fluids (102) in the annulus (128) may decrease. In these cases, the ESP string (112) may be removed and resized. Once the fluids (102) reach the surface (114), the fluids (102) flow through the wellhead (134) into production equipment (136). The production equipment (136) may be any equipment that can gather or transport the fluids (102) such as a pipeline or a tank.

The remainder of the ESP system (100) includes various surface equipment (110) such as electric drives (137), production controller (138), the control module, and an electric power supply (140). The electric power supply (140) provides energy to the motor (118) through the power cable (126). The electric power supply (140) may be a commercial power distribution system or a portable power source such as a generator. The production controller (138) is made up of an assortment of intelligent unit-programmable controllers and drives which maintain the proper flow of electricity to the motor (118) such as fixed-frequency switchboards, soft-start controllers, and variable speed controllers. The production controller (138) may be a variable speed drive (VSD), well choke, inflow control valve, and/or sliding sleeves. The production controller (138) is configured to perform automatic well operation adjustments. The electric drives (137) may be variable speed drives which read the downhole data, recorded by the sensors, and may scale back or ramp up the motor (118) speed to optimize the pump (124) efficiency and production rate. The electric drives (137) allow the pump (124) to operate continuously and intermittently or be shut-off in the event of an operational problem.

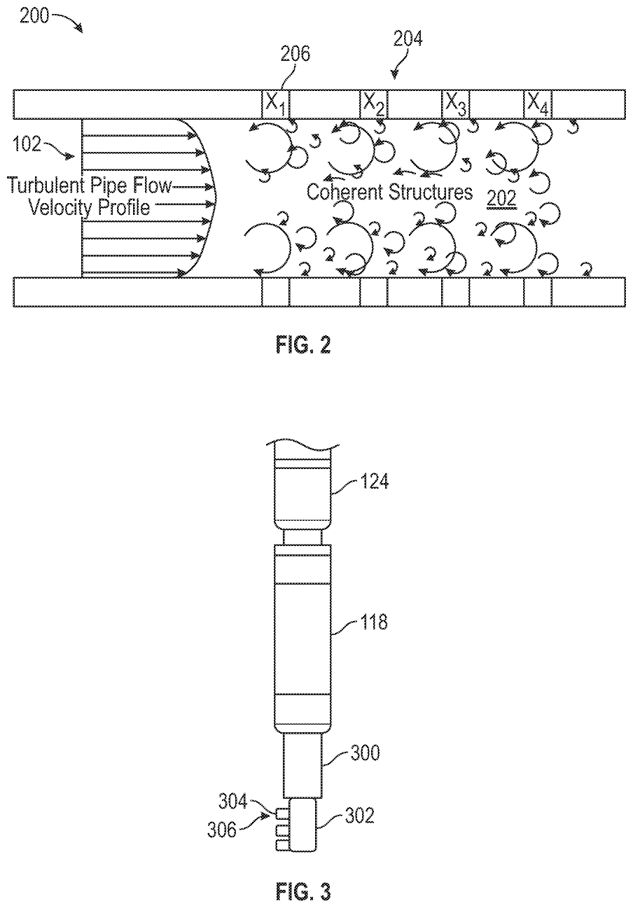

FIG. 2 shows a cross sectional view of a pipe's (200) flow velocity profile. The pipe (200) may be production tubing (117). Fluids (102) may travel in an inherent turbulent nature. The turbulent flow may cause the formation of coherent structures (202). The coherent structures (202) may be vortices. The coherent structures (202) may result in production of acoustic waves. The acoustic waves may cause pressure/energy loss in the fluid flow. The acoustic waves may be represented by small-scale local tornadoes illustrated in FIG. 2. The acoustic waves may produce noise. The acoustic waves generated may travel with and against the direction of fluid flow. The acoustic waves traveling with the direction of fluid flow may be referred to as “right traveling.” The acoustic waves traveling against the direction of fluid flow may be referred to as “left traveling.” The acoustic waves may travel through the fluid (102) at the speed of sound. The acoustic waves may cause small pressure fluctuations in fluid flow. The small pressure fluctuations may be sensed using a sensor array (204). The sensor array (204) may include an array of sensitive strain sensors (206) along the wall of the pipe (200) or flowline.

The acoustic waves traveling in the direction of fluid flow may be sped up by an amount equal to the fluid velocity. The acoustic waves traveling against the direction of fluid flow may be slowed down by an amount equal to the fluid velocity. Half of the difference in velocity between the right traveling and the left traveling acoustic waves may equal the flow velocity of the fluid (102). In ESP (124) applications, the ESP (124) may create noise. The ESP (124) may create noise due to it being a turbo-mechanical device. The noise produced from the ESP (124) may be transmitted to all flow lines connected to the ESP (124). The production controller (138) may cause additional spurious frequencies to be injected to the ESP (124) and the motor (118). The additional spurious frequencies may cause a high-vibration environment. Due to the high-vibration environment in ESP (124) applications, the sensor array shown in FIG. 2 may be inoperable.

FIG. 3 shows a system in accordance with one or more embodiments. The system may be used in high-vibration environments, such as ESP (124) applications. FIG. 3 shows a system for determining flow rate of a fluid (102) in a well (116). The system in FIG. 3 may be referred to as “flowmeter” in one or more embodiments. Specifically, the flow rate of the fluid (102) may be measured below or downhole from the ESP (124). FIG. 3 shows an ESP (124) and motor (118) disposed in the well (116). A downhole sensor module (300) may be connected to the motor (118). A person of ordinary skill in the art may appreciate that the downhole sensor module (300) may be auxiliary equipment as commonly used in the industry. The downhole sensor module (300) may house sensors. The sensors may include standard pressure, temperature, and vibration.

A metering module (302) may be installed extending from the downhole sensor module (300). The metering module (302) may be an extension of the downhole sensor module (300) by an additional 6 to 24 inches. The metering module (302) may be of the shape such as a hollow tube, flat-sided cylinder, or prism. The metering module (302) may be made of a material configured to resist bending movement in a perpendicular direction to the vertical axis of the ESP (124). The metering module (302) may include a plurality of dynamic pressure sensors (304) along a vertical axis of the ESP (124). The dynamic pressure sensors (304) may be piezoelectric. The piezoelectric element may be built into a silicon chip with measurement circuits in the dynamic pressure sensor (304). The piezoelectric element in the dynamic pressure sensor (304) converts strain caused by fluid pressure into voltage. The metering module (302) may have a bottom. The bottom may prevent vibration from being transmitted perpendicular to fluid flow direction. The bottom may be made of a heavier material than the rest of the metering module (302).

The metering module may have at least three dynamic pressure sensors (304). The dynamic pressure sensors (304) may be connected to the outer diameter of the metering module (302). The dynamic pressure sensors (304) may be installed directly on the downhole sensor module (300). The dynamic pressure sensors (304) may measure pressure fluctuation of the fluid (102). Specifically, the dynamic pressure sensors (304) may measure pressure fluctuation of the fluid (102) below the ESP (124). An array of dynamic pressure sensors (304) may be located downhole from the ESP (124) to measure the flow rate of the fluids (102). The dynamic pressure sensors (304) may be mounted with a vibration control mechanism (306). The vibration control mechanism (306) may be integrated. The vibration control mechanism (306) may prevent the effect of vibration or noise from being transmitted from the ESP (124) to the dynamic pressure sensors (304). The vibration control mechanism (306) may be located on the metering module (302). The dynamic pressure sensors (304) may be powered by the downhole sensor module (300). The power supply of the downhole sensor module (300) may be an alternating current based gauge.

A person of ordinary skill in the art may appreciate that the flowmeter described in FIG. 3 may be utilized in a canned motor-pump application. The fluids (102) may flow through the canned motor-pump. Measurements of flow may be more reliable and straightforward due to the fluid (102) flowing through a full wellbore. Fluid flow may be channeled into the canned motor-pump through a pump intake (130). The pump intake (130) may include dynamic pressure sensors (304) embedded in an inside wall of the pump intake (130) or flowmeter. Data analysis may be managed locally in the pump intake (130) and/or an adjacent gauge. Greater processing capability may be possible. Pump (124) and motor (118) noise cancelling attenuation may be applied to improve flow accuracy.

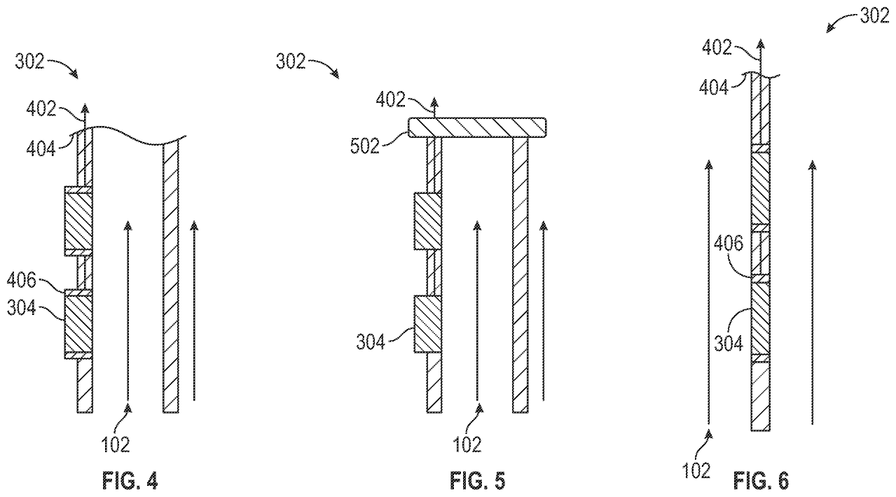

FIGS. 4-7 show examples of the system in FIG. 3 in accordance with one or more embodiments. The electrical connection (402) to the downhole sensor module (300) is illustrated by an arrow in FIGS. 4-7. The mechanical connection (404) to the downhole sensor module (300) is illustrated by two parallel curved lines in FIGS. 4, 6, and 7. The fluid (102) directional flow is illustrated by two arrows in FIGS. 4-7. The system described may be used for mechanical damping and algorithmic compensation of vibration in a flow line, such as the ESP string (112). External vibration measurements may be used to compensate measurements from the dynamic pressure sensors (304).

FIG. 4 shows the metering module (302) with individually isolated dynamic pressure sensors (304). The vibration control mechanism (306) may include a vibration isolating mount (406) for each dynamic pressure sensor (304). The vibration isolating mount (406) may be threaded into the metering module (302). The vibration isolating mount (406) may be an elastomer plug fitted into the metering module (302). Vibration damping may be passive. The vibration isolating mount (406) may be rubber-like plug on which the dynamic pressure sensor (304) is mounted. The vibration isolating mount (406) may plug into the metering module (302). A person of ordinary skill in the art may appreciate that the vibration control mechanism (306) on the metering module (302) may cut out frequencies. The frequencies may be low or high. In some embodiments, the frequencies may be but are not limited to 50 Hertz (Hz), 60 Hz, and odd multiples of Hz. For example, 1 kHz from the production controller (138) may be prevented from getting transmitted to the dynamic pressure sensor (304).

FIG. 5 shows the metering module (302) mounted with the vibration control mechanism (306) as a vibration isolator (502). The vibration isolator (502) may be located at the connection of the metering module (302) to the downhole sensor module (300).

FIG. 6 shows the array of dynamic pressure sensors (304) mounted on a stump-like shaped metering module (302). The metering module (302) may not need to be shaped as a hollow-tube.

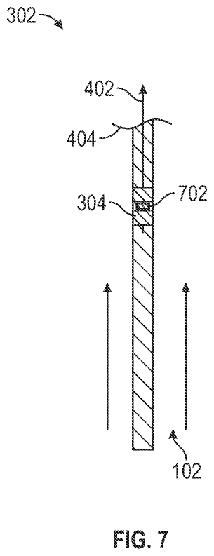

FIG. 7 shows the metering module (302) without the vibration control mechanism (306). An accelerometer (702) may replace the vibration control mechanism (306). The accelerometer (702) may be integrated into the dynamic pressure sensor (304). As explained in FIG. 3, a silicon chip may be included in the dynamic pressure sensor (304). The silicon chip may include an accelerometer (702). The acceleration and pressure measurements may be acquired in the same location when the accelerometer (702) is integrated into the dynamic pressure sensor (304). In some embodiments, the metering module (302) may include the vibration control mechanism (306) and the accelerometer (702). The accelerometer (702) may be disposed on the metering module (302). The accelerometer (702) may measure the acceleration in the two directions perpendicular to the direction of fluid (102) flow at points close to the dynamic pressure sensors (304). The two directions may be a first perpendicular direction and a second perpendicular direction of the fluid (102) flow direction. The two directions perpendicular may be diaphragm direction measurements. The effect of vibration of the metering module (302) on the dynamic pressure sensors (304) may be compensated by knowing the acceleration experienced by the metering module (302).

The dynamic pressure sensors (304) may have an additional pressure fluctuation. The magnitude of the additional pressure fluctuation on the dynamic pressure sensor (304) may be proportional to the force exerted by the fluid (102) against it. The additional pressure fluctuation may be due to movement of the metering module (302). The accelerometer (702) measures the frequencies at which the pressure fluctuations are being imposed on the dynamic pressure sensor (304). In one or more embodiment, the metering module (302) may be calibrated with accelerometers (702) installed on it. A sensitivity to external vibration of the metering module (302) may be predetermined. The effect of external vibration may be removed. A person of ordinary skill in the art may appreciate the known method of sensor compensation using calibration. Higher vibration frequencies, such as 12 kHz, may have an impact of the dynamic pressure sensor (304) measurement. However, lower vibration frequencies, such as 6 kHz, may have limited impact.

In one or more embodiment, sensor compensation may be executed by subtracting signals from two dynamic pressure sensor (304) that may experience external vibration in opposing directions. The dynamic pressure sensors (304) may be installed such that their measuring diaphragms are facing opposite directions. In some embodiments, the metering module (302) may move from vibration from the ESP (124). Additional fluid force on one of the dynamic pressure sensors (304) may decrease along with an equivalent fluid force decrease on the other dynamic pressure sensor. The accelerometer (702) may be used to measure the vibration of the metering module (302) at the location of movement.

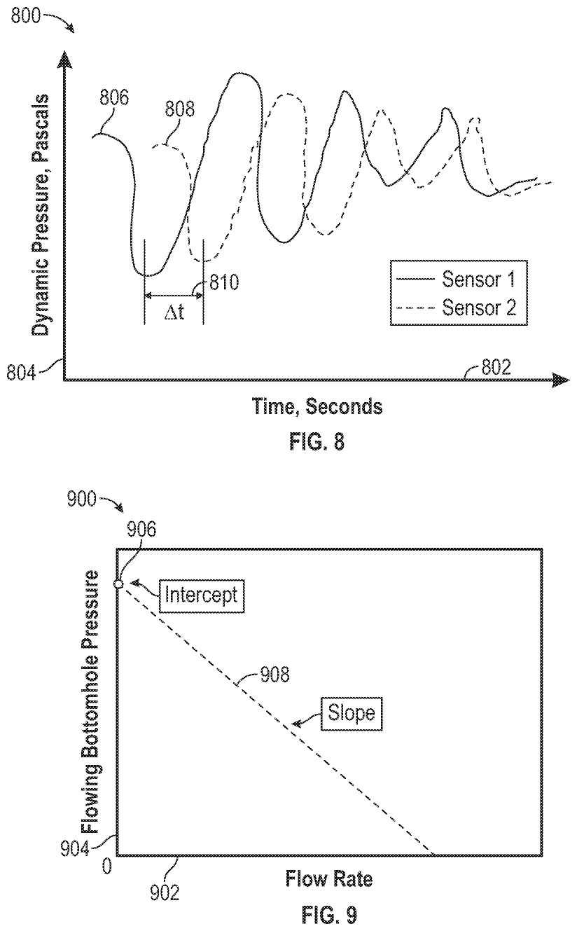

FIG. 8 shows cross-correlation (800) of dynamic pressure measurements. The x-axis (802) shows time measured in seconds. The y-axis (804) shows dynamic pressure measured in pascals. Vibration compensated dynamic pressure measurements from multiple dynamic pressure sensors (304) along the flow direction may be cross correlated to achieve bulk flow velocity. FIG. 8 shows 2 dynamic pressure sensors (304), now referred to as sensor 1 (806) and sensor 2 (808), with respective measurements. As shown in FIG. 8, sensor 2 (808) is close to a time-shifted version of sensor 1 (806) measurement, as indicated by Δt (810). The distance (d) between sensor 1 (806) and sensor 2 (808) is known. The fluid velocity may be d/Δt. The calculation of d/Δt may be repeated over signal segments between sensor 1 (806) and sensor 2 (808). The variation in flow rate may be plotted with respect to time. Additional dynamic pressure sensors (304) may provide additional estimates of flow velocity for uncertainty reduction.

The speed of the acoustic waves traveling with the fluid (102) may be estimated using the fluid velocity. If the fluid (102) is a mixture of oil and water, the speed of sound may be used to measure the water fraction. The gas content in the fluid (102) may be <10% by volume. Speed of sound may provide an indication of gas volume fraction (GVF). GVF, static pressure, and temperature measurement in the downhole sensor module (300) may provide validation of phase behavior of the fluid (102). If more than expected gas is produced, a gas breakthrough may be indicated.

FIG. 9 shows a graph in accordance with one or more embodiments. One of the main advantages of the flowmeter described in FIGS. 3-8 includes the ability to measure the flow rate downhole from the ESP (124). FIG. 9 shows an example of the flow rate of the fluids (102) downhole from the ESP (124) as an in-flow performance relationship (IPR) curve (900). The flow rate is shown by the x-axis (902). The flowing bottom-hole pressure is shown on the y-axis (904). The y-intercept of the IPR curve (900) may be the reservoir pressure (906). The in-flow performance relationship may be evaluated using the slope (908). The IPR curve (900) may be evaluating using algorithms by controlling pressure on surface and/or speed of the ESP (124). The IPR curve (900) may be determined before installation of the ESP (124). The IPR curve (900) may be monitored during the lifetime of the well (116) to determine change in permeability. Permeability is the capacity of a rock layer to transmit fluids, such as fluids (102). A model of the well (116) from the reservoir to the surface production flow line may be developed.

Flow rates may be estimated from pressure-temperature values at key points in the model, such as in the formation (104), pump intake (130) side downhole from the ESP (124), discharge side above the ESP (124), and on surface (114) at the well choke. Flow rate across the system on a mass basis may be identical. Fluids (102) may have different densities and dissolution rates in other phases. The volumetric flow rate of the total fluid (102) may not be conserved. By measuring the volumetric flow rate and density of the fluid (102) below or downhole from the ESP (124), an evaluation of the drawdown from the reservoir for different flowing bottom-hole pressures may be possible. The flowing bottom-hole pressures may be varied by running the ESP (124) at different speeds or by opening and closing the surface choke. The IPR curve (900) may be reevaluated at any point in the well's (116) lifetime using the system described in FIGS. 3-8.

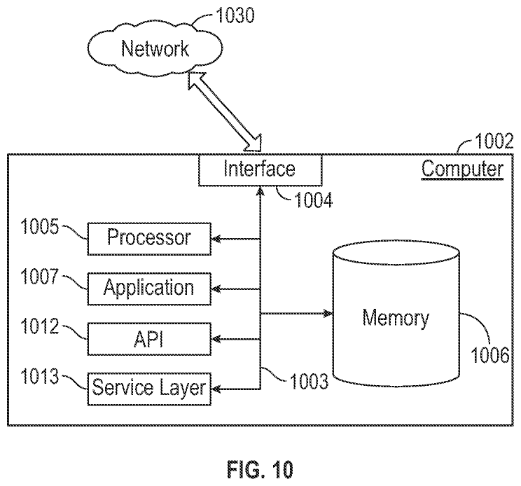

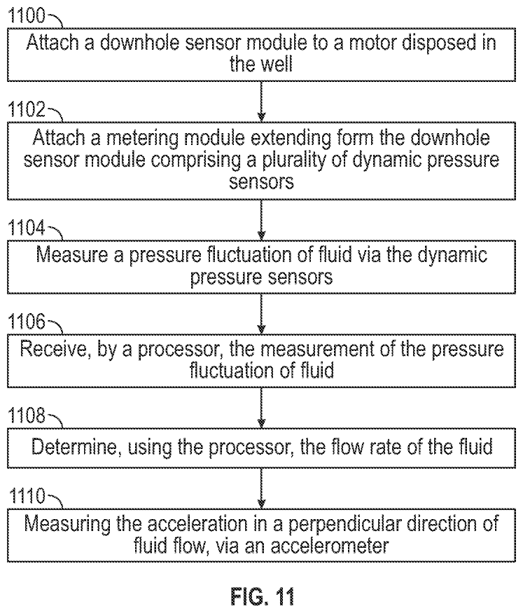

FIG. 10 shows a computer system in accordance with one or more embodiments. Embodiments may be implemented on a computer system. FIG. 10 is a block diagram of a computer (1002) used to provide computational functionalities associated with described algorithms, methods, functions, processes, flows, and procedures as described in the instant disclosure, according to an implementation. The illustrated computer (1002) is intended to encompass any computing device such as a server, desktop computer, laptop/notebook computer, wireless data port, smart phone, personal data assistant (PDA), tablet computing device, one or more processors within these devices, or any other suitable processing device, including both physical or virtual instances (or both) of the computing device. Additionally, the computer (1002) may include a computer that includes an input device, such as a keypad, keyboard, touch screen, or other device that can accept user information, and an output device that conveys information associated with the operation of the computer (1002), including digital data, visual, or audio information (or a combination of information), or a GUI.

The computer (1002) can serve in a role as a client, network component, a server, a database or other persistency, or any other component (or a combination of roles) of a computer system for performing the subject matter described in the instant disclosure. The illustrated computer (1002) is communicably coupled with a network (1030). In some implementations, one or more components of the computer (1002) may be configured to operate within environments, including cloud-computing-based, local, global, or other environment (or a combination of environments).

At a high level, the computer (1002) is an electronic computing device operable to receive, transmit, process, store, or manage data and information associated with the described subject matter. According to some implementations, the computer (1002) may also include or be communicably coupled with an application server, e-mail server, web server, caching server, streaming data server, business intelligence (BI) server, or other server (or a combination of servers).

The computer (1002) can receive requests over network (1030) from a client application (for example, executing on another computer (1002)) and responding to the received requests by processing the said requests in an appropriate software application. In addition, requests may also be sent to the computer (1002) from internal users (for example, from a command console or by other appropriate access method), external or third-parties, other automated applications, as well as any other appropriate entities, individuals, systems, or computers.

Each of the components of the computer (1002) can communicate using a system bus (1003). In some implementations, any or all of the components of the computer (1002), both hardware or software (or a combination of hardware and software), may interface with each other or the interface (1004) (or a combination of both) over the system bus (1003) using an application programming interface (API) (1012) or a service layer (1013) (or a combination of the API (1012) and service layer (1013). The API (1012) may include specifications for routines, data structures, and object classes. The API (1012) may be either computer-language independent or dependent and refer to a complete interface, a single function, or even a set of APIs. The service layer (1013) provides software services to the computer (1002) or other components (whether or not illustrated) that are communicably coupled to the computer (1002). The functionality of the computer (1002) may be accessible for all service consumers using this service layer. Software services, such as those provided by the service layer (1013), provide reusable, defined business functionalities through a defined interface. For example, the interface may be software written in JAVA, C++, or other suitable language providing data in extensible markup language (XML) format or other suitable format. While illustrated as an integrated component of the computer (1002), alternative implementations may illustrate the API (1012) or the service layer (1013) as stand-alone components in relation to other components of the computer (1002) or other components (whether or not illustrated) that are communicably coupled to the computer (1002). Moreover, any or all parts of the API (1012) or the service layer (1013) may be implemented as child or sub-modules of another software module, enterprise application, or hardware module without departing from the scope of this disclosure.

The computer (1002) includes an interface (1004). Although illustrated as a single interface (1004) in FIG. 10, two or more interfaces (1004) may be used according to particular needs, desires, or particular implementations of the computer (1002). The interface (1004) is used by the computer (1002) for communicating with other systems in a distributed environment that are connected to the network (1030). Generally, the interface (1004 includes logic encoded in software or hardware (or a combination of software and hardware) and operable to communicate with the network (1030). More specifically, the interface (1004) may include software supporting one or more communication protocols associated with communications such that the network (1030) or interface's hardware is operable to communicate physical signals within and outside of the illustrated computer (1002).

The computer (1002) includes at least one processor (1005). Although illustrated as a single processor (1005) in FIG. 10, two or more processors may be used according to particular needs, desires, or particular implementations of the computer (1002). Generally, the processor (1005) executes instructions and manipulates data to perform the operations of the computer (1002) and any algorithms, methods, functions, processes, flows, and procedures as described in the instant disclosure. The processor (1005) may be configured to receive data from the dynamic pressure sensors (304) described in FIGS. 3-8. The processor (1005) may determine the flow rate of the fluid (102) based on the received data from the dynamic pressure sensors (304).

The computer (1002) also includes a memory (1006) that holds data for the computer (1002) or other components (or a combination of both) that can be connected to the network (1030). For example, memory (1006) can be a database storing data consistent with this disclosure. Although illustrated as a single memory (1006) in FIG. 10, two or more memories may be used according to particular needs, desires, or particular implementations of the computer (1002) and the described functionality. While memory (1006) is illustrated as an integral component of the computer (1002), in alternative implementations, memory (1006) can be external to the computer (1002).

The application (1007) is an algorithmic software engine providing functionality according to particular needs, desires, or particular implementations of the computer (1002), particularly with respect to functionality described in this disclosure. For example, application (1007) can serve as one or more components, modules, applications, etc. Further, although illustrated as a single application (1007), the application (1007) may be implemented as multiple applications (1007) on the computer (1002). In addition, although illustrated as integral to the computer (1002), in alternative implementations, the application (1007) can be external to the computer (1002).

There may be any number of computers (1002) associated with, or external to, a computer system containing computer (1002), each computer (1002) communicating over network (1030). Further, the term “client,” “user,” and other appropriate terminology may be used interchangeably as appropriate without departing from the scope of this disclosure. Moreover, this disclosure contemplates that many users may use one computer (1002), or that one user may use multiple computers (1002).

FIG. 11 shows a flowchart in accordance with one or more embodiments. Specifically, FIG. 11 describes for measuring a flow rate of a fluid in a well (116). One or more blocks in FIG. 11 may be performed by one or more components as described in FIGS. 1-10. While the various blocks in FIG. 11 are presented and described sequentially, one of ordinary skill in the art will appreciate that some or all of the blocks may be executed in different orders, may be combined or omitted, and some or all of the blocks may be executed in parallel. Furthermore, the blocks may be performed actively or passively.

In Block 1100, a downhole sensor module (300) is attached to a motor (118) in the well (116). The motor (118) may be attached to an ESP (124). The downhole sensor module (300) may be extended by an additional 6 to 24 inches. In Block 1102, a metering module (302) extending from the downhole sensor module (300) is attached. The metering module (302) may have a plurality of dynamic pressure sensors (304) along the vertical axis of the ESP (124). The plurality of dynamic pressure sensors (304) may include at least three dynamic pressure sensors (304). The metering module (302) may be a hollow tube, flat-sided cylinder, or a prism. The metering module (302) may be configured to resist a bending movement in the perpendicular direction of the vertical axis of the ESP (124). The metering module (302) may include a bottom. The bottom may be configured to prevent the vibration from being transmitted perpendicular to the fluid (102) flow direction.

The metering module (302) may have a vibration control mechanism (306). The vibration control mechanism (306) may be configured to prevent a vibration from being transmitted to the dynamic pressure sensors (304). The vibration control mechanism (306) may be disposed in a location where the downhole sensor module (300) connects to the metering module (302). The vibration control mechanism (306) may have a vibration isolating mount (406) for each of the dynamic pressure sensors (304). The vibration isolating mount (406) may be threaded into the metering module (302). The vibration isolating mount may be an elastomer plug fitted into the metering module (302). The metering module (302) may have an accelerometer to measure the acceleration in a first perpendicular direction and a second perpendicular direction of the fluid (102) flow direction.

In Block 1104, pressure fluctuation of the fluid (102) is measured, via the dynamic pressure sensors (304). The dynamic pressure sensors (304) may be connected to the outer diameter of the metering module (302). In Block 1106, the measurement of the pressure fluctuation of the fluid (102) is received by a processor (1005). In Block 1108, the flow rate is determined using the processor (1005). The flow rate may be based on the measurement of the pressure fluctuation of the fluid (102). In Block 1110, acceleration is measure in a perpendicular direction of fluid flow, via the accelerometer (702). Specifically, the acceleration is measured in a first perpendicular direction and a second perpendicular direction of the fluid flow direction.

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims. In the claims, means-plus-function clauses are intended to cover the structures described herein as performing the recited function and not only structural equivalents, but also equivalent structures. Thus, although a nail and a screw may not be structural equivalents in that a nail employs a cylindrical surface to secure wooden parts together, whereas a screw employs a helical surface, in the environment of fastening wooden parts, a nail and a screw may be equivalent structures. It is the express intention of the applicant not to invoke 35 U.S.C. § 112(f) for any limitations of any of the claims herein, except for those in which the claim expressly uses the words ‘means for’ together with an associated function.

What is claimed is:

1. A system for determining a flow rate of a fluid in a well, the system comprising:
an electrical submersible pump disposed in the well,
wherein the electrical submersible pump comprises a vertical axis;
a motor disposed on the electrical submersible pump;
a downhole sensor module connected to the motor;
a metering module extending from the downhole sensor module comprising a plurality of dynamic pressure sensors along the vertical axis,
wherein the plurality of dynamic pressure sensors are connected to an outer diameter of the metering module,
wherein the plurality of dynamic pressure sensors are configured to measure a pressure fluctuation of the fluid; and
a processor configured to receive data from the plurality of dynamic pressure sensors and determine the flow rate of the fluid based on the received data.

2. The system of claim 1, further comprising:
a vibration control mechanism disposed on the metering module,
wherein the vibration control mechanism is configured to prevent a vibration from being transmitted to the plurality of dynamic pressure sensors.

3. The system of claim 2, wherein the vibration control mechanism comprises a vibration isolating mount for each of the plurality of dynamic pressure sensors, wherein the vibration isolating mount is threaded into the metering module.

4. The system of claim 3, wherein the vibration isolating mount is an elastomer plug fitted into the metering module.

5. The system of claim 2, wherein the vibration control mechanism is disposed in a location where the downhole sensor module connects to the metering module.

6. The system of claim 1, further comprising:
an accelerometer disposed on the metering module,
wherein the accelerometer is configured to measure an acceleration in a first perpendicular direction and a second perpendicular direction of a fluid flow direction.

7. The system of claim 1, wherein the downhole sensor module is extended by an additional 6 to 24 inches.

8. The system of claim 1, wherein the metering module is a hollow tube, flat-sided cylinder, or prism.

9. The system of claim 1, wherein the metering module comprises a bottom, wherein the bottom is configured to prevent the vibration from being transmitted perpendicular to a fluid flow direction.

10. The system of claim 1, wherein the plurality of dynamic pressure sensors comprises at least three dynamic pressure sensors.

11. A method for measuring a flow rate of a fluid in a well, the method comprising:
attaching a downhole sensor module to a motor disposed in the well,
wherein the motor is attached to an electrical submersible pump having a vertical axis;
attaching a metering module extending from the downhole sensor module,
wherein the metering module comprises a plurality of dynamic pressure sensors along the vertical axis,
measuring a pressure fluctuation of the fluid, via the plurality of dynamic pressure sensors connected to an outer diameter of the metering module;
receiving, by a processor, the measurement of the pressure fluctuation of the fluid; and
determining, using the processor, the flow rate based on the measurement of the pressure fluctuation of the fluid.

12. The method of claim 11, further comprising:
attaching a vibration control mechanism on the metering module,
wherein the vibration control mechanism is configured to prevent a vibration from being transmitted to the plurality of dynamic pressure sensors.

13. The method of claim 12, wherein the vibration control mechanism comprises a vibration isolating mount for each of the plurality dynamic pressure sensors, wherein the vibration isolating mount is threaded into the metering module.

14. The method of claim 13, wherein the vibration isolating mount is an elastomer plug fitted into the metering module.

15. The method of claim 12, wherein the vibration control mechanism is disposed in a location where the downhole sensor module connects to the metering module.

16. The method of claim 11, further comprising:
measuring an acceleration in a first perpendicular direction and a second perpendicular direction of a fluid flow direction, via an accelerometer disposed on the metering module.

17. The method of claim 11, wherein the downhole sensor module is extended by an additional 6 to 24 inches.

18. The method of claim 11, wherein the metering module is a hollow tube, flat-sided cylinder, or prism.

19. The method of claim 11, wherein the metering module comprises a bottom, wherein the bottom is configured to prevent the vibration from being transmitted perpendicular to a fluid flow direction.

20. The method of claim 11, wherein the plurality of dynamic pressure sensors comprises at least three dynamic pressure sensors.
